(19) United States
(12) Patent Application Publication
(10) Pub. No.: US 2026/0352939 A1
(43) Pub. Date: Nov. 5, 2026

(54) METHOD AND SYSTEM FOR SYNCHRONIZING VIDEO FRAMES CAPTURED BY MULTIPLE CAMERAS

(71) Applicant: Musco Corporation, Oskaloosa, IA (US)

(72) Inventors: Russell M. Dobbins, Earlham, IA (US); Sin Yong Tan, West Des Moines, IA (US); Venkata Karthik Sai Madala, West Des Moines, IA (US); Andrew J. Schembs, Johnston, IA (US); Cobi J. Sabo, Denver, CO (US)

(21) Appl. No.: 19/665,542

(22) Filed: May 1, 2026

Related U.S. Application Data
(60) Provisional application No. 63/798,262, filed on May 1, 2025.

(51) Int. Cl. H04N 23/61; G06T 3/18; G06T 5/80; G06T 7/13; G06V 10/25; G06V 10/26; G06V 10/44; G06V 10/75; G06V 10/98; G06V 20/40

(52) U.S. Cl. CPC H04N 23/61; G06T 3/18; G06T 5/80; G06T 7/13; G06V 10/25; G06V 10/26; G06V 10/44; G06V 10/751; G06V 10/993; G06V 20/46; G06T 2207/10016

(57) ABSTRACT

A method for synchronizing video frames captured from multiple cameras, comprising capturing frames from a first camera and a second camera, processing the captured frames to extract feature sets, comparing the feature sets of the frames from the first camera with the feature sets of the frames from the second camera to identify a correspondence between the frames, and synchronizing the video frames of the first camera and the second camera based on the identified correspondence. The method enables precise frame alignment without reliance on external synchronization mechanisms, improving temporal consistency and reducing artifacts in multi-camera systems.

### RELATED APPLICATIONS

This application claims the benefit of U.S. Provisional Application No. 63/798,262, filed May 1, 2025, the entire contents of which are incorporated herein.

### TECHNICAL FIELD

The disclosure relates to image processing and computer vision.

### BACKGROUND OF THE INVENTION

In many modern imaging applications, multiple cameras are often strategically deployed to capture complementary views of a scene. These systems are widely utilized in fields such as live event broadcasting, sports streaming, surveillance, and immersive multimedia, where merging different video feeds creates a richer, unified visual experience. However, coordinating the capture from devices that operate independently poses significant challenges. Variations in startup times, exposure settings, and processing delays can lead to noticeable discrepancies in the recorded sequences. Thus, ensuring that the individual feeds align coherently is an important aspect of delivering a seamless overall presentation. The integration of these independently captured images remains a substantial technical consideration, especially as the demand for high-quality, synchronized multimedia outputs continues to grow.

The objective of combining multiple camera feeds is to achieve a smooth and cohesive visual narrative that meets the stringent requirements of both live broadcasting and post-production applications. Precise alignment of video streams is necessary for eliminating visual inconsistencies such as duplicated elements or temporal distortions, which can detract from the overall image quality. In applications where a panoramic or multi-angle view is required, even minor misalignments can lead to distracting artifacts that compromise the viewer's experience.

A common challenge encountered in multi-camera systems is achieving robust temporal synchronization among video frames captured by different sensors. As cameras typically operate asynchronously, variations in capture timing and network-induced delays can lead to uneven frame alignment. Standard approaches, which often depend on shared triggers or time codes, may not adequately address the variability that arises across independently operating devices. These discrepancies can lead to visual disturbances, where overlapping or misaligned segments disrupt the continuity of the composite image. Such issues are particularly problematic in dynamic environments where rapid movement or changing light conditions amplify the effects of any timing misalignment, negatively impacting the overall fidelity and clarity of the integrated output.

In certain high-activity scenarios, subtle timing differences among camera feeds become particularly problematic, resulting in visible artifacts such as ghosting, where objects appear duplicated or blurred. This specific issue arises when frames captured at slightly different moments are combined, leading to an overlay of non-synchronous images that diminishes both visual clarity and user experience. Additionally, reliance on external synchronization mechanisms, while sometimes effective, can be impractical and cost prohibitive for many applications.

### SUMMARY OF THE INVENTION

In general, the disclosure describes techniques for synchronizing a first camera and a second camera based on captured frames from the first camera and the second camera. The techniques include causing, by one or more processors, a capturing of at least a first frame from a first camera and a set of frames from a second camera, processing, by the one or more processors, the first frame and each frame in the set of frames to extract feature sets for each captured frame, comparing, by the one or more processors, the feature set of the first frame from the first camera with the feature sets of each of the frames in the set of frames from the second camera to identify a second frame that most closely corresponds to the first frame, and synchronizing, by the one or more processors, the first camera and the second camera based on the first frame of the first camera and the identified second frame of the second camera.

The techniques of this disclosure may provide one or more advantages. For example, by processing captured frames to extract feature sets and comparing the feature set of the first frame with feature sets of a set of frames, one or more processors can identify a second frame that most closely corresponds to the first frame and can determine a frame offset value between the first frame and the second frame corresponding to a temporal delay determined based on the identified second frame. By synchronizing the first camera and the second camera based on the first frame and the identified second frame, the techniques can facilitate alignment of captured frames from the first camera and the second camera. In some examples, buffering a plurality of frames from the second camera may facilitate selection of the second frame from the set of frames that yields a maximum confidence score during comparison, and setting the frame offset value to equal zero in response to the standard deviation not meeting a threshold standard deviation may avoid applying a frame offset value when confidence scores do not satisfy the threshold standard deviation.

In one example, the disclosure is directed to a method that includes causing, by one or more processors, a capturing of at least a first frame from a first camera and a set of frames from a second camera. The method further includes processing, by the one or more processors, the first frame and each frame in the set of frames to extract feature sets for each captured frame. The method also includes comparing, by the one or more processors, the feature set of the first frame from the first camera with the feature sets of each of the frames in the set of frames from the second camera to identify a second frame that most closely corresponds to the first frame. The method further includes synchronizing, by the one or more processors, the first camera and the second camera based on the first frame of the first camera and the identified second frame of the second camera.

In another example, the processing may further include de-warping, by the one or more processors, each captured frame to correct for lens distortion. The processing may further include cropping, by the one or more processors, a region of interest from each de-warped frame corresponding to an overlapping area between the first camera and the second camera. Extracting the feature sets may include applying, by the one or more processors, an edge detection algorithm to each captured frame to identify edge features. Comparing the feature set of the first frame with the feature sets of the set of frames may include computing, by the one or more processors, a confidence score based on a quantity of matching edges. Computing the confidence score may include calculating, by the one or more processors, a standard deviation of the matching edge counts across the set of frames. Extracting the feature sets may further include filtering, by the one or more processors, the detected edges to retain a predetermined number of edge matches with the top scores.

In another example, synchronizing the first camera and the second camera may include determining, by the one or more processors, a frame offset value between the first frame and the second frame corresponding to a temporal delay determined based on the identified second frame. Synchronizing the first camera and the second camera may further include shifting, by the one or more processors, the frames from the second camera by the frame offset. The method may further include, for each frame in the set of frames, determining, by the one or more processors, a confidence score based on the comparison of the feature set of the first frame and the feature set of the respective frame, determining a standard deviation of the confidence scores, and, in response to the standard deviation not meeting a threshold standard deviation, setting, by the one or more processors, the frame offset value to equal zero.

In another example, the method may further include buffering, by the one or more processors, a plurality of frames from the second camera to facilitate selection of the second frame from the set of frames that yields a maximum confidence score during comparison. Processing the captured frames may further include converting, by the one or more processors, each frame to a grayscale format prior to performing de-warping and edge detection. Comparing the feature set of the first frame with the feature sets of the set of frames may further include applying, by the one or more processors, a k-neighbors matching algorithm followed by performing Lowe's ratio test to filter out low quality matches. The set of frames may each have a timestamp within a pre-defined range of a timestamp for the first frame.

In another example, the disclosure is directed to a method for performing any of the techniques described herein. In another example, the disclosure is directed to a device configured to perform any of the methods described herein. In another example, the disclosure is directed to an apparatus comprising means for performing any of the methods described herein. In another example, the disclosure is directed to a non-transitory computer-readable storage medium having stored thereon instructions that, when executed, cause one or more processors of a computing device to perform any of the methods described herein. In another example, the disclosure is directed to a system comprising one or more computing devices configured to perform any of the methods described herein. In another example, the disclosure is directed to any of the techniques described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a block diagram illustrating a streaming system configured to synchronize feeds from multiple cameras, in accordance with one or more techniques described herein.

FIG. 2 is a block diagram illustrating a more detailed example of a computing device configured to perform the techniques described herein.

FIG. 3 is a conceptual diagram illustrating video frames from two cameras during a synchronization process, in accordance with one or more techniques described herein.

FIG. 4 is a flow diagram illustrating an example method of synchronizing frames from multiple cameras, in accordance with one or more techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

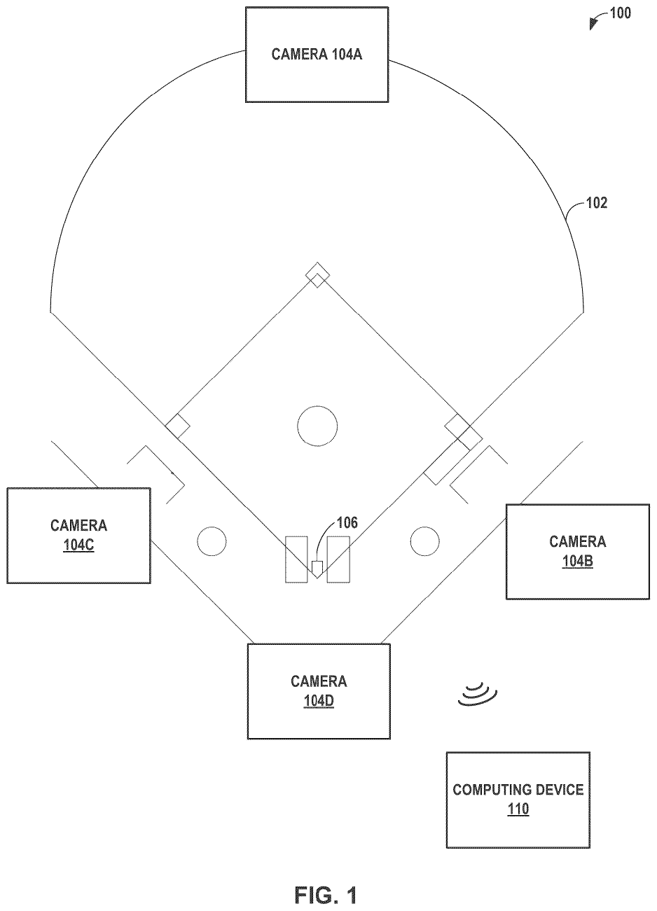

FIG. 1 is a conceptual diagram illustrating streaming system 100 that includes sports field 102 with cameras 104A-104D (collectively, cameras 104) installed on location with a computing device 110 for synchronizing the camera streams, in accordance with one or more techniques described herein. While the example of FIG. 1 illustrates video system 100 with four instances of cameras 104, other instances of video system 100 may include more cameras or fewer cameras. For instance, video system 100 may only include cameras 104A and 104B, cameras 104A and 104C, cameras 104A-C, or any other combination of cameras, including only camera 104B or 104C if those cameras are stereoscopic cameras (e.g., camera 104B is a system of two cameras arranged to function as a stereoscopic system).

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Cameras 104 may be any camera capable of recording a video stream and transmitting that video stream to computing device 110, either wirelessly or through a wired connection. Each of cameras 104 may be directed at home plate 106 such that home plate 106 is a common focal point in each of the video streams recorded by the respective one of cameras 104, meaning that home plate 106 is present and visible in the video streams at least when no obstructions are on sports field 102.

In accordance with the techniques described herein, computing device 110 may cause a capturing of at least a first frame from a first camera (e.g., camera 104A) and a set of frames from a second camera (e.g., camera 104B). In this example, computing device 110 may process the first frame and each frame in the set of frames to extract feature sets for each captured frame. Computing device 110 may compare the feature set of the first frame from the first camera 104A with the feature sets of each of the frames in the set of frames from the second camera 104B to identify a second frame that most closely corresponds to the first frame. Computing device 110 may synchronize the first camera 104A and the second camera 104B based on the first frame of the first camera 104A and the identified second frame of the second camera 104B. This process may be performed for any two cameras from cameras 104A, 104B, 104C, and 104D, any may be performed multiple times to synchronize multiple cameras (e.g., performing this process for camera 104A against each of cameras 104B, 104C, and 104D such that individual frame offsets are assigned to each of cameras 104B, 104C, and 104D while camera 104A remains constant). The method ensures precise synchronization of video frames captured by multiple cameras, eliminating temporal misalignment and reducing visual artifacts such as ghosting in multi-camera systems.

In accordance with the techniques of this disclosure, a method for synchronizing frames taken by different video cameras is shown. This approach eliminates the necessity of external clock to synchronize. A single frame from the first camera and a collection of frames from the second camera are first captured, and then edge detection is applied to both the first and each of the second frames. To ascertain whether the frame with the highest match count is an accurate match, a scoring method is used to assess the number of matching edges. This method improves spatial consistency and synchronization for a variety of applications by guaranteeing exact frame alignment across numerous camera feeds.

In general, this disclosure describes techniques for synchronizing frames captured by multiple cameras in a system 100. As shown in FIG. 1, the system 100 includes a structure 102, a plurality of cameras 104A-104D supported by or otherwise associated with the structure 102, a component 106, and a computing device 110. Although FIG. 1 illustrates four cameras 104A-104D, the disclosed techniques may be implemented using two cameras or more than two cameras. The computing device 110 includes one or more processors configured to process image data received from the cameras 104A-104D and to determine a temporal relationship between frames captured by different cameras based on visual features appearing in the captured frames.

The cameras 104A-104D may capture respective streams of frames from different viewpoints. At least two of the cameras 104A-104D may have overlapping fields of view such that a portion of a scene is visible in frames captured by each of the at least two cameras. The cameras 104A-104D need not be synchronized using a shared shutter trigger, an external synchronization signal, or a pre-synchronized universal clock. Instead, the computing device 110 may determine an offset between frames captured by different cameras by comparing image features extracted from captured frames.

In one example, the computing device 110 causes capture of at least a first frame from a first camera, such as the camera 104A, and a set of frames from a second camera, such as the camera 104B. The set of frames may include frames captured within a predefined time range relative to the first frame or frames stored in a buffer associated with the second camera. The computing device 110 processes the first frame and each frame in the set of frames to extract respective feature sets. The computing device 110 compares the feature set of the first frame with the feature set of each frame in the set of frames to identify a second frame that most closely corresponds to the first frame. Based on the identified second frame, the computing device 110 synchronizes the first camera and the second camera.

The synchronization may include determining a frame offset value corresponding to a temporal delay between the first frame and the identified second frame. The computing device 110 may apply the frame offset value by shifting frames from the second camera relative to frames from the first camera. In this manner, the computing device 110 can align frames captured by different cameras even when the cameras begin capturing at different times, operate without a shared synchronization signal, or otherwise produce streams that are temporally misaligned.

The frame offset value may be represented as a frame count, a timestamp difference, a time duration, or another value indicating a temporal relationship between the first frame and the identified second frame. In one convention, the frame offset value may be calculated as an index, timestamp, or frame number associated with the identified second frame minus an index, timestamp, or frame number associated with the first frame. Under that convention, a positive frame offset value indicates that the second camera feed is delayed relative to the first camera feed by the frame offset value, and a negative frame offset value indicates that the second camera feed is advanced relative to the first camera feed by the magnitude of the frame offset value. Other sign conventions may be used if applied consistently by the computing device 110.

The computing device 110 may shift frames from the second camera by applying the frame offset value to a buffer, playback queue, processing queue, frame index, or timestamp associated with the second camera feed. For example, when the frame offset value indicates that the second camera feed is delayed relative to the first camera feed, the computing device 110 may delay frames from the first camera, advance buffered frames from the second camera, discard one or more frames from the second camera, or re-index timestamps so that corresponding frames are processed together. When the frame offset value indicates that the second camera feed is advanced relative to the first camera feed, the computing device 110 may delay frames from the second camera, advance buffered frames from the first camera, duplicate or hold one or more frames, or re-index timestamps so that corresponding frames are processed together. The particular shifting operation may depend on whether the synchronized output is generated in real time, near real time, or after capture.

After synchronizing the first camera feed and the second camera feed, the computing device 110 may output synchronized video data based on the temporally aligned frames. The synchronized video data may include a synchronized video stream including frames from the first camera and frames from the second camera aligned according to the frame offset value, separate synchronized camera feeds having adjusted timestamps or frame indices, or a composite video stream generated from the synchronized camera feeds. The computing device 110 may provide the synchronized video data to a display device, a storage device, a streaming server, a broadcast encoder, a video stitching system, a panoramic-view generator, an object-tracking system, a surveillance system, a stereo-vision system, or another downstream video processing system. In this manner, the frame offset value may be used not only to identify a temporal relationship between camera feeds, but also to generate, store, transmit, display, or further process video data in which frames from multiple cameras are temporally aligned.

The computing device 110 may process captured frames before comparing the captured frames. For example, the computing device 110 may convert a captured frame to grayscale, de-warp the captured frame to correct for lens distortion, and crop a region of interest corresponding to an overlapping area between a field of view of the first camera and a field of view of the second camera. The computing device 110 may then extract edge features or other image features from the processed frame. In some examples, the computing device 110 applies an edge detection algorithm to identify edge features, applies an Oriented FAST and Rotated BRIEF algorithm to determine feature points or descriptors, applies a k-neighbor matching algorithm to compare features, and applies Lowe's ratio test to filter low quality matches.

As used herein, a feature set extracted from a frame can include one or more visual features detectable in image data of the frame. The visual features can include edge features, contours, corners, interest points, feature points, descriptors, gradients, pixel-intensity transitions, texture features, object boundaries, line segments, shape characteristics, or other detectable image characteristics usable to compare a portion of one frame with a portion of another frame. An edge feature can include any image characteristic indicating a transition between image regions, including a gradient, boundary, contour, or detected line segment. A descriptor can include data generated from pixels surrounding an interest point or feature point, including data generated by an Oriented FAST and Rotated BRIEF algorithm or another feature-detection or feature-description algorithm. Accordingly, extracting a feature set need not require extraction limited to edges and can include extracting any combination of edges, interest points, descriptors, and other visual features that support frame-to-frame comparison.

The computing device 110 may determine a confidence score for each candidate frame in the set of frames from the second camera based on a comparison between the feature set of the first frame and the feature set of the candidate frame. The confidence score may be based on a quantity of matching edges, a quantity of matching feature descriptors, or another measure of visual correspondence between the first frame and the candidate frame. The computing device 110 may identify the candidate frame having a maximum confidence score as the second frame that most closely corresponds to the first frame.

The computing device 110 may further evaluate whether the comparison provides a sufficiently reliable indication of frame correspondence. For example, the computing device 110 may determine a standard deviation of confidence scores or matching feature counts across the set of frames. When the standard deviation satisfies a threshold, the computing device 110 may determine that the candidate frame associated with the maximum confidence score represents a clear correspondence to the first frame. When the standard deviation does not satisfy the threshold, the computing device 110 may determine that no reliable correspondence has been identified and may set the frame offset value to zero or repeat the comparison using another frame from the first camera.

When the comparison of the first frame with the set of candidate frames does not identify a sufficiently distinct corresponding frame, the computing device 110 may determine that a reliable frame offset value has not been established for the first frame. In response, the computing device 110 may refrain from applying a new frame offset value for the camera pair, may set the frame offset value to zero, may keep the camera feeds in their existing temporal relationship for that comparison cycle, may select a different reference frame from the first camera, or may select a different set of candidate frames from the second camera. In some examples, the different set of candidate frames may be selected by moving a candidate-frame window forward or backward in the second camera feed, by increasing a size of the candidate-frame window, or by selecting frames associated with a different timestamp range. The computing device 110 may repeat the feature extraction, feature comparison, confidence-score determination, and reliability evaluation until a sufficiently distinct corresponding frame is identified or until a stopping condition is satisfied.

The threshold used to evaluate whether a candidate correspondence is sufficiently distinct may be a predetermined value, a user-configured value, a value selected based on a frame rate of one or more cameras 104, a value selected based on an expected latency range between camera feeds, a value selected based on a size of the candidate-frame window, a value selected based on scene activity in the overlapping region of interest, or a value determined during calibration of the system 100. In some examples, the threshold may be adaptive and may be updated based on one or more previously determined confidence scores, matching feature counts, standard deviations, frame offsets, or reliability determinations. The threshold may be applied to a standard deviation of confidence scores, a standard deviation of matching feature counts, a difference between a top confidence score and a next-ranked confidence score, a ratio between confidence scores, or another metric indicating whether one candidate frame is sufficiently more similar to the first frame than other candidate frames in the set of candidate frames.

By identifying corresponding frames based on visual features in overlapping portions of captured scenes, the computing device 110 may reduce temporal misalignment between camera streams. Reducing temporal misalignment may reduce ghosting artifacts or other artifacts that can occur when frames captured at different times are stitched, combined, or otherwise analyzed together. The disclosed techniques may be used in multi-camera video systems, including live streaming systems, sports broadcasting systems, panoramic imaging systems, surveillance systems, object tracking systems, stereo vision systems, and other computer vision systems in which temporal alignment of camera feeds is used to generate or analyze multi-camera video output.

The disclosed techniques improve the operation of a multi-camera video system by providing a particular computer-implemented process for determining and applying temporal alignment between independently operating camera feeds. Rather than merely using a computer as a tool to perform a generic comparison, the computing device performs ordered image-processing operations on captured video frames, including selecting a reference frame from a first camera, selecting a set of candidate frames from a second camera, processing the reference frame and the candidate frames to extract feature sets, comparing the extracted feature sets to identify a corresponding candidate frame, determining a frame offset value based on the identified corresponding candidate frame, and shifting frames of at least one camera feed according to the frame offset value. These operations are directed to a technical problem arising in multi-camera imaging systems, namely temporal misalignment caused by asynchronous capture, nondeterministic start times, network latency, camera-specific processing delays, and the absence of a shared shutter trigger or pre-synchronized clock.

The disclosed techniques provide a technical improvement to image processing and computer vision systems by deriving synchronization from image content in captured frames. The computing device may de-warp captured frames to correct lens distortion, crop a region of interest corresponding to an overlapping field-of-view area, convert frames to grayscale, identify edge features or other visual features, determine interest points and descriptors, apply a k-neighbor matching algorithm, apply Lowe's ratio test to filter low-quality matches, and compute confidence metrics based on matching features. By limiting comparison to an overlapping region of interest and by filtering lower-quality feature matches, the computing device reduces computational complexity and improves the reliability of frame matching when different camera views contain only partially overlapping scene content.

The disclosed techniques also improve the reliability of multi-camera synchronization by evaluating whether a candidate correspondence is sufficiently distinct from other candidate correspondences before applying a frame shift. For example, the computing device may determine a confidence score for each candidate frame in the set of candidate frames and may determine a standard deviation of the confidence scores or matching feature counts across the set of candidate frames. A relatively distinct confidence result may indicate that one candidate frame corresponds to the reference frame, while a non-distinct confidence result may indicate that no reliable correspondence has been found. In response to a non-distinct confidence result, the computing device may refrain from applying an erroneous frame offset value, may set the frame offset value to zero, or may repeat the comparison using another reference frame. This conditional control improves the functioning of the multi-camera video system by reducing incorrect synchronization decisions that can otherwise introduce or worsen ghosting, duplicated objects, blurred motion, temporal discontinuities, or other visual artifacts in stitched, combined, or analyzed video output.

The disclosed techniques are rooted in computer technology because they address synchronization of digital video streams produced by multiple cameras and use computer vision operations to modify the timing relationship between those streams. The output of the process is not merely information displayed to a user, but a changed configuration or timing relationship of camera feeds in which frames from one camera are aligned with corresponding frames from another camera based on a computed offset. The resulting synchronized streams can be used by downstream video stitching, panoramic imaging, object tracking, stereo vision, live streaming, sports broadcasting, surveillance, or other computer vision processes with reduced temporal inconsistency.

The disclosed techniques accordingly provide a practical application of frame feature extraction, feature matching, confidence scoring, and frame shifting to improve a specific technical process in multi-camera video systems. The particular arrangement of capturing a reference frame and a set of candidate frames, extracting feature sets from the captured frames, identifying a corresponding candidate frame based on feature comparison and confidence evaluation, and synchronizing the camera feeds according to a determined frame offset provides a concrete technological solution to the technical problem of aligning asynchronously captured video streams without requiring external synchronization hardware or a pre-synchronized universal clock.

Multi-camera systems have found applications that require detection of objects and maintaining track of them. For example, multi camera systems are used in real time streaming for giving a panoramic view to users. Mobile phones also give a panoramic view as an option for their users. Using multi-camera systems in place of single camera systems have advantages. Strategically placed multiple cameras can provide a better sense of depth and spatial awareness. Multi-camera systems are also effective for live broadcasts where quick switching between cameras is essential. Streaming can also be adjusted to wide, medium, and close in real time during streaming.

While multi-camera systems have their own advantages, there are challenges to using these systems. One such challenge is the synchronization of frames captured from multiple cameras. Even though it can be done by using common shutter switches for all those cameras, such an approach is not cost effective for applications.

Another challenge in using multi-camera systems is if streaming is through a network, it is nondeterministic to find the start time of each camera. As such, comparing just the first frame in each camera is not an ideal solution.

The techniques described herein provide methods of synchronization which do not depend on a shutter switch or synchronizing the time. These techniques dynamically find the best possible match ensuring accurate synchronization even in scenarios where cameras have asynchronous or unknown starting point.

In some instances, images may be de-warped before processing. De-warping rectifies distortion of the image which makes straight lines appear straighter and helps shapes to be properly aligned. This helps in having better results while applying edge detection algorithms.

In a video recording system, for example, with two cameras having the same frame rate pointing towards the same scene, it is difficult to keep those cameras fully synchronized in a universal clock. Surveillance systems and live streaming of sports like soccer and football are few such scenarios where video capturing process does not start at the same time for both cameras. This will cause delay by an undetermined amount and will have adverse effects if these captures are used in any other application. The solution of frame synchronization involves frame shifting based on the corresponding match.

The movement of an object should be in view of all the cameras so that the movement of the object provides key information for matching frames. Each frame may be cropped to the overlapping area to ensure the locations of objects correspond in the following steps. Object rotation and position can be identified by running edge detection on each individual frame. This helps to find the best match frames by finding frames which have the best matching rotation and position of edges. A score may also be assigned to the match to determine how dependable the match is and the higher the number of objects in the frame, the higher the score is. The shift need not to be a frame number. It can also be a timestamp if an application in which the invention is integrated supports them.

Key points are found for both the first camera and group of frames in the second camera using ORB algorithm. The frame from the first camera is compared with each frame from the second camera using KNN matching algorithm. Two best matches for each key point where the best matches are the ones with smallest distance measurement are preserved. To ensure quality of the match Lowe's ratio test is performed and two distances which are sufficiently different are filtered out for next steps.

As the matching and Lowe's ratio test on a frame from a left camera and one from a right camera, each pair will have matches which passed Lowe's ratio test. Later standard deviation is applied on the matches of each pair. If the standard deviation is high, then pair then match with highest number of matches is a good match but if standard deviation is low there is no clear match. This helps to prevent synchronizing unmatched matches and perform matching from the next frame from the first camera to find the exact match.

Each camera may have its own distortion, which may be rectified for better edge detection. Key points are commuted using ORB matcher and the KNN matching algorithm is used to find matches and Lowes's algorithm is used to filter low quality matches. Later a score is assigned based on the number of matches.

In one scenario, it may be assumed there are no objects in the frames i.e., there is no activity in the place where cameras are pointed. In this scenario, then each frame from the first camera and group of frames from the second camera are captured and edge detection and KNN matching algorithms are applied. Even though there are edges and matches which are similar, the techniques of this disclosure may find a confidence score using standard deviation which is low because each frame from the second camera has a match with frame from the first camera. The system may determine there is no clear match and tried to find a match from the next frame of second camera.

In another scenario, it may be assumed there is lot of activity in the place where cameras are pointed. Then each frame from the first camera and group of frames from the second camera are captured by the cameras and edge detection and KNN matching algorithms are applied. In this case there are rotational and positional changes from consecutive frames. So, the best match frame will have higher matches compared to other frames. This results in high confidence score result of high standard deviation. This will show how many frames to skip from a respective camera to maintain synchronization. In other words, there is one unique match where rotation and position are matched.

The techniques of this disclosure are related to image processing including precise frame-matching technique for synchronizing footage from multiple cameras aimed at the same scene, enhancing edge-based accuracy and reliability.

Frame matching is an technique in computer vision applications, including object recognition, multi-camera tracking, stereo vision, and image stitching. However, frames need not have exactly same content because only a small portion might be overlapped between two frames, and cameras may not start capturing simultaneously, especially in live stream scenarios. In the case of live streams, the difference between two consecutive frames might not differ, so score may be given to match to determine quality of the match.

Multi-camera systems are widely used in applications requiring panoramic views, object tracking, and real-time video streaming. These systems offer significant advantages over single-camera setups, such as enhanced spatial awareness, depth perception, and the ability to capture wide-angle views by stitching multiple camera feeds. However, despite their benefits, multi-camera systems face several challenges, particularly in ensuring synchronization between the video feeds captured by different cameras.

One of the primary issues in multi-camera systems is the lack of reliable synchronization between cameras. In scenarios where cameras operate independently, such as in networked environments, variations in startup times, network latency, and frame capture rates can lead to temporal misalignment between the video feeds. This misalignment results in inconsistencies when stitching frames from multiple cameras, often manifesting as “ghosting” effects, where objects appear duplicated or distorted in the overlapping regions of the stitched image. Such artifacts degrade the quality of the video output and can be particularly problematic in applications like live sports broadcasting, surveillance, and panoramic imaging.

Existing solutions to address synchronization in multi-camera systems often rely on external hardware, such as shutter synchronization mechanisms or universal clocks, to ensure simultaneous frame capture. While effective, these approaches are costly and impractical for many applications, particularly those requiring scalability or operating in dynamic environments. Additionally, software-based methods that attempt to align frames post-capture often struggle to achieve precise synchronization due to variability in frame timing and content. These limitations highlight the need for a more robust and cost-effective solution to synchronize video feeds in multi-camera systems.

The present disclosure provides a method for synchronizing video frames captured by multiple cameras without relying on external hardware or pre-synchronized clocks. By leveraging advanced image processing techniques, the described method dynamically identifies and aligns corresponding frames from different camera feeds, ensuring accurate synchronization even in scenarios where cameras have asynchronous or unknown starting points. This approach eliminates ghosting artifacts and enhances the spatial consistency of stitched video feeds, offering a reliable and scalable solution for multi-camera systems in various applications.

In one example implementation, the system 100 is deployed at a sports field 102 to generate a synchronized multi-camera video stream of a live sporting event. Cameras 104A-104D are installed at different locations around the sports field 102 and are oriented so that each camera captures a respective view of at least a portion of the sports field 102. For example, each of the cameras 104A-104D can be positioned such that home plate 106 or another common region of the sports field 102 is visible in each captured video stream. The cameras 104A-104D transmit respective video streams to the computing device 110 through wired connections, wireless connections, or a combination of wired and wireless connections. Because the cameras 104A-104D can be powered on at different times, can begin capture at different times, and can transmit video through network paths having different latencies, frames received by the computing device 110 from the cameras 104A-104D can be temporally misaligned even when the cameras 104A-104D are directed toward the same scene.

During operation, the computing device 110 selects a frame from a first camera 104A as a reference frame and selects a set of frames from a second camera 104B as candidate frames. The set of frames from the second camera 104B can include frames buffered by the computing device 110 and having timestamps within a predefined range of a timestamp associated with the reference frame. The computing device 110 converts the reference frame and the candidate frames to grayscale, de-warps the frames to correct lens distortion, and crops each frame to a region of interest corresponding to an overlapping portion of the views captured by the first camera 104A and the second camera 104B. In the sports field example, the region of interest can include home plate 106, a batter, a runner, a ball, field markings, or another feature or object visible in the overlapping portions of the captured video streams.

The computing device 110 extracts feature sets from the cropped regions of the reference frame and the candidate frames. For example, the computing device 110 can identify edge features, interest points, descriptors, or other visual features associated with objects or markings in the region of interest. The computing device 110 compares the feature set of the reference frame with the feature set of each candidate frame from the second camera 104B using a matching algorithm, such as a k-neighbor matching algorithm, and filters low quality matches using Lowe's ratio test. The computing device 110 determines a confidence score for each candidate frame based on a quantity of matching features and determines whether the confidence scores indicate a sufficiently distinct match. For example, when a player, ball, or other object moves through the overlapping region of interest, one candidate frame from the second camera 104B may have a substantially higher number of matching features than adjacent candidate frames.

When the computing device 110 identifies a candidate frame from the second camera 104B that most closely corresponds to the reference frame from the first camera 104A, the computing device 110 determines a frame offset value corresponding to a temporal delay between the reference frame and the identified candidate frame. The computing device 110 shifts frames from the second camera 104B according to the frame offset value so that frames from the second camera 104B are temporally aligned with corresponding frames from the first camera 104A. The computing device 110 can repeat this process for additional camera pairs, such as synchronizing camera 104C and camera 104D to camera 104A, thereby generating synchronized streams from multiple cameras around the sports field 102.

The synchronized streams may be provided to a downstream video processing system that stitches the streams, switches between camera views, generates a panoramic view, tracks objects, or produces a live broadcast output. By synchronizing the camera streams based on visual features in captured frames, the computing device 110 can reduce ghosting, duplicated objects, blurred motion, and other temporal artifacts that can occur when video streams captured at different times are combined or analyzed together. If the confidence scores for a set of candidate frames do not satisfy a threshold, the computing device 110 can set the frame offset value to zero or perform the matching process using another reference frame, thereby avoiding application of a frame shift based on an ambiguous match.

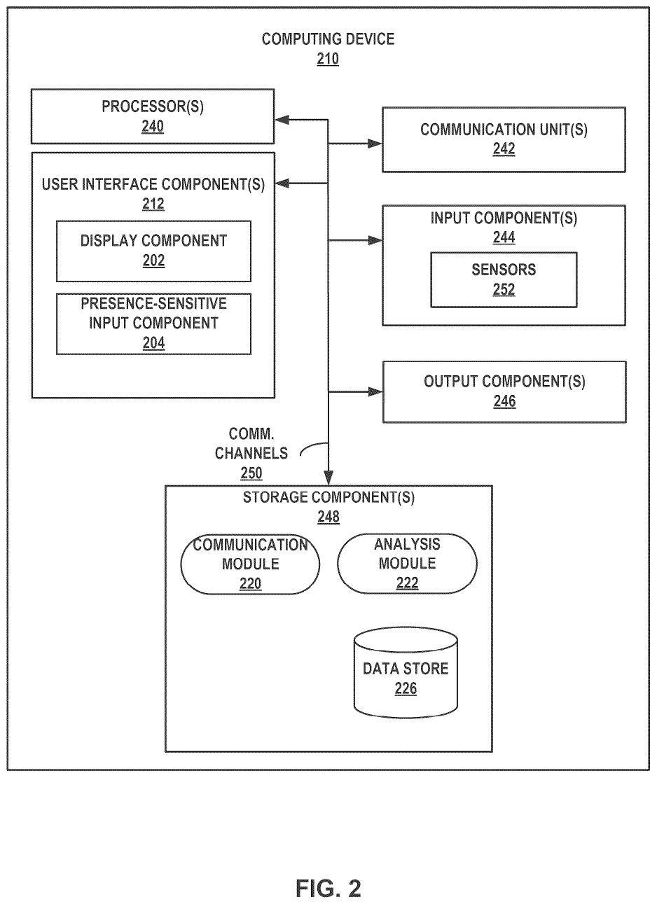

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to synchronize multiple cameras. That is, processors 240 may implement functionality and/or execute instructions associated with computing device 210 to extract features from frames captures by multiple cameras and compare the extracted features to determine an offset to apply to one of the cameras such that the real life objects captured by the cameras are aligned temporally after processing.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 extract features from frames captures by multiple cameras and compare the extracted features to determine an offset to apply to one of the cameras such that the real life objects captured by the cameras are aligned temporally after processing.

Communication module 220 may execute locally (e.g., at processors 240) to provide functions associated with communicating capture commands to cameras and causing the cameras to become synchronized. In some examples, communication module 220 may act as an interface to a remote service accessible to computing device 210. For example, communication module 220 may be an interface or application programming interface (API) to a remote server that communicates capture commands to cameras and causes the cameras to become synchronized.

In some examples, analysis module 222 may execute locally (e.g., at processors 240) to provide functions associated with extracting frame features and calculating frame offsets. In some examples, analysis module 222 may act as an interface to a remote service accessible to computing device 210. For example, analysis module 222 may be an interface or application programming interface (API) to a remote server that extracts frame features and calculates frame offsets.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may cause a capturing of at least a first frame from a first camera and a set of frames from a second camera. In some instances, the set of frames each have a timestamp within a pre-defined range of a timestamp for the first frame. Restricting the set of frames to those with timestamps within a predefined range of the first frame's timestamp reduces the search space, improving processing efficiency and synchronization accuracy.

Analysis module 222 may process the first frame and each frame in the set of frames to extract feature sets for each captured frame. In some instances, in processing the frames, analysis module 222 may de-warp each captured frame to correct for lens distortion. De-warping the captured frames corrects lens distortion, improving the accuracy of feature extraction and enhancing the reliability of frame matching.

Additionally or alternatively in processing the frames, analysis module 222 may cropping, by the one or more processors, a region of interest from each de-warped frame corresponding to an overlapping area between the first camera and the second camera. Cropping the overlapping region of interest focuses the processing on the shared area between the cameras, reducing computational complexity and improving the precision of frame alignment.

Additionally or alternatively in processing the frames and extracting the feature sets, analysis module 222 may applying, by the one or more processors, an edge detection algorithm to each captured frame to identify edge features. Applying an edge detection algorithm enables the identification of key features in the frames, facilitating accurate comparison and matching between frames from different cameras.

Additionally or alternatively in processing the frames and extracting the feature sets, analysis module 222 may filter the detected edges to retain a predetermined number of edge matches with the top scores. Filtering the detected edges to retain a predetermined number of top-scoring matches enhances the quality of the feature set, ensuring that only the most relevant edges are used for comparison.

In some instances, during the processing of the captured frames, analysis module 222 may convert each frame to a grayscale format prior to performing de-warping and edge detection. Converting each frame to grayscale format prior to processing reduces computational complexity and enhances the effectiveness of de-warping and edge detection algorithms.

Analysis module 222 may compare the feature set of the first frame from the first camera with the feature sets of each of the frames in the set of frames from the second camera to identify a second frame that most closely corresponds to the first frame. In some instances, in comparing the feature set of the first frame with the feature sets of the set of frames, analysis module 222 may compute a confidence score based on a quantity of matching edges. Computing a confidence score based on the quantity of matching edges provides a quantitative measure of the quality of the match, ensuring reliable synchronization.

In some such instances, in computing the confidence score, analysis module 222 may calculate a standard deviation of the matching edge counts across the set of frames. Calculating the standard deviation of matching edge counts improves the robustness of the confidence score by identifying clear matches and avoiding ambiguous frame alignments.

Additionally or alternatively, in comparing the feature set of the first frame with the feature sets of the set of frames, analysis module 222 may apply a k-neighbors matching algorithm followed by performing Lowe's ratio test to filter out low quality matches. Applying a k-neighbors matching algorithm followed by Lowe's ratio test filters out low-quality matches, ensuring that only high-confidence matches are used for synchronization.

Communication module 220 may synchronize the first camera and the second camera based on the first frame of the first camera and the identified second frame of the second camera. In some instances, in synchronizing the first camera and the second camera, analysis module 222 may determine a frame offset value between the first frame and the second frame corresponding to a temporal delay determined based on the identified second frame. Determining a frame offset value based on the identified matching frame allows for precise temporal adjustment of the second camera feed, ensuring accurate synchronization. In some such instances, in synchronizing the first camera and the second camera, communication module 220 may shift the frames from the second camera by the frame offset. Shifting the frames from the second camera by the frame offset ensures temporal alignment between the camera feeds, reducing visual inconsistencies in the combined output.

Additionally or alternatively, for each frame in the set of frames, analysis module 222 may determine a confidence score based on the comparison of the feature set of the first frame and the feature set of the respective frame; determining a standard deviation of the confidence scores. In response to the standard deviation not meeting a threshold standard deviation, communication module 220 may set the frame offset value to equal zero. Setting the frame offset value to zero when the standard deviation fails to meet a threshold prevents synchronization errors in scenarios with low confidence, ensuring reliable operation.

In some instances, communication module 220 may buffer a plurality of frames from the second camera to facilitate selection of the frame that yields a maximum confidence score during comparison. Buffering a plurality of frames from the second camera facilitates the selection of the frame with the highest confidence score, improving the accuracy of synchronization.

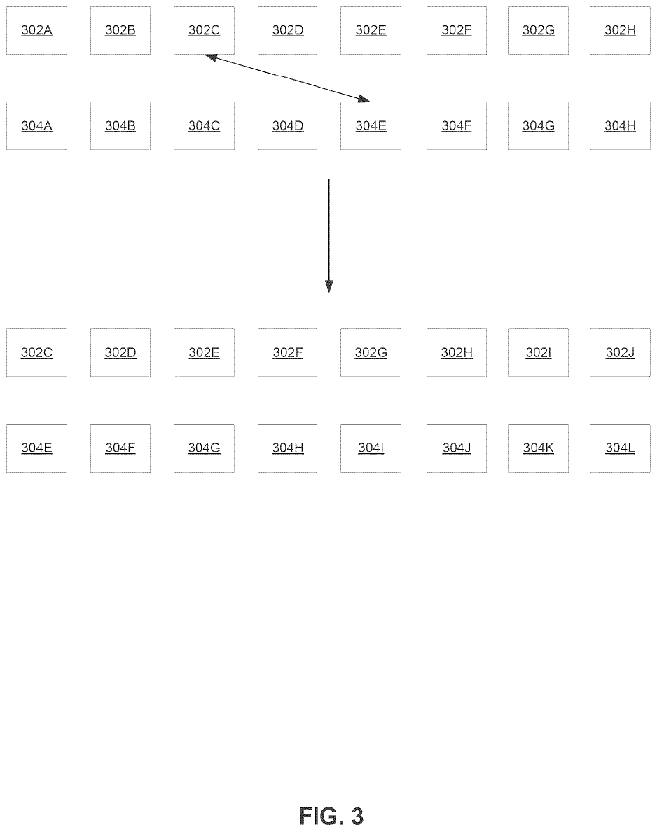

FIG. 3 is a conceptual diagram illustrating video frames from two cameras during a synchronization process, in accordance with one or more techniques described herein. As shown in FIG. 3, frames 302A, 302B, 302C, 302D, 302E, 302F, 302G, 302H, 302I, and 302J, collectively referred to as frames 302, represent video frames captured by a first camera. Frames 304A, 304B, 304C, 304D, 304E, 304F, 304G, 304H, 304I, 304J, 304K, and 304L, collectively referred to as frames 304, represent video frames captured by a second camera. Frames 302 and frames 304 may be captured by different cameras having partially overlapping fields of view, such that at least some objects, markings, edges, or other visual features appearing in frames 302 are also visible in frames 304. The first camera and the second camera may operate without a shared shutter trigger, without a common hardware synchronization signal, or without a pre-synchronized universal clock. Accordingly, frames that are initially paired or output at approximately the same time by the camera feeds may not represent the same instant in the captured scene.

FIG. 3 illustrates an example synchronization process in which one or more processors select frame 302C from frames 302 as a reference frame and select frames 304 from the second camera as candidate frames for comparison with frame 302C. In some examples, the candidate frames are selected based on a timestamp range, a frame-number range, or a buffer window relative to frame 302C. The timestamp range or frame-number range may be selected to include candidate frames that are likely to include a frame corresponding to frame 302C while excluding frames that are too temporally distant to provide a useful comparison. Although FIG. 3 shows frame 302C as the reference frame and frames 304 as the candidate frames, another one of frames 302 may be selected as the reference frame, frames from the first camera may be compared against a reference frame from the second camera, or the same process may be repeated for additional pairs of cameras.

The processors process frame 302C and each of the selected candidate frames 304 to generate feature sets for comparison. The processing may include converting the frames to grayscale, de-warping the frames to compensate for lens distortion, and cropping the frames to a region of interest corresponding to an overlapping portion of the fields of view of the first camera and the second camera. The processors may then extract image features from the cropped regions. The extracted image features may include edge features, interest points, descriptors, or other visual features that can be matched between frames. In some examples, the processors apply an edge detection algorithm, an Oriented FAST and Rotated BRIEF algorithm, a k-neighbor matching algorithm, and Lowe's ratio test to identify and filter feature matches between frame 302C and each candidate frame 304.

For each candidate frame 304, the processors compare the feature set extracted from frame 302C with the feature set extracted from the candidate frame and determine a confidence score representing a degree of correspondence between the two frames. The confidence score may be based on a number of matching edge features, a number of matching descriptors, a distribution of matched features within the region of interest, a quality metric associated with the matched features, or a combination thereof. The processors may compare the confidence scores for the candidate frames 304 to identify the candidate frame that most closely corresponds to frame 302C.

In the example shown in FIG. 3, the processors determine that frame 304E from the second camera most closely corresponds to frame 302C from the first camera. This determination indicates that frame 304E, rather than frame 304C or another initially corresponding frame, depicts the scene at a time that most closely corresponds to the time represented by frame 302C. The processors may determine a frame offset value based on the position, timestamp, or frame number of frame 304E relative to frame 302C. In the illustrated example, the frame offset value is-2 when calculated by subtracting a timestamp number or frame number associated with frame 302C from a timestamp number or frame number associated with frame 304E. Other conventions may be used to calculate or represent the offset, including using an opposite sign convention or expressing the offset as a time value rather than a frame count.

After determining the frame offset value, the processors may synchronize the first camera feed and the second camera feed by shifting frames 304 relative to frames 302 according to the frame offset value. Shifting frames 304 can cause frame 304E to be aligned with frame 302C for downstream processing, output, or storage. The downstream processing may include stitching video streams, generating a panoramic view, switching between camera angles, tracking an object across camera views, determining three-dimensional information, or otherwise analyzing multi-camera video data. By applying the frame offset determined from visual feature correspondence, the processors reduce temporal mismatch between frames captured by the first camera and the second camera.

The processors may also evaluate whether the candidate-frame comparison produces a sufficiently reliable synchronization result. For example, the processors may determine a standard deviation of confidence scores or matching feature counts across frames 304. When the confidence score for frame 304E is sufficiently distinct from confidence scores for other candidate frames, the processors may apply the determined frame offset value. When the confidence scores are not sufficiently distinct, the processors may determine that the comparison did not identify a reliable corresponding frame, may set the frame offset value to zero, may maintain a previously determined frame offset value, or may repeat the comparison using another reference frame from frames 302. This reliability evaluation reduces the likelihood that the system will apply an erroneous offset when the scene contains insufficient motion, insufficient overlapping visual detail, repeated visual patterns, occlusions, blur, or other conditions that make frame matching ambiguous.

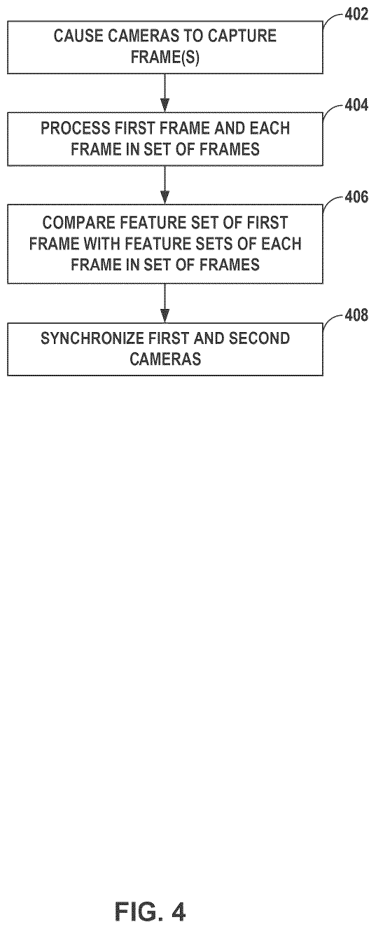

FIG. 4 is a flow diagram illustrating an example method of synchronizing frames from multiple cameras, in accordance with one or more techniques described herein. The techniques of FIG. 4 may be performed by one or more processors of a computing device, such as system 100 of FIG. 1 and/or computing device 210 illustrated in FIG. 2. For purposes of illustration only, the techniques of FIG. 4 are described within the context of computing device 210 of FIG. 2, although computing devices having configurations different than that of computing device 210 may perform the techniques of FIG. 4.

In accordance with the techniques of this disclosure, communication module 220 causes a capturing of at least a first frame from a first camera and a set of frames from a second camera (402). Analysis module 222 processes the first frame and each frame in the set of frames to extract feature sets for each captured frame (404). Analysis module 222 compares the feature set of the first frame from the first camera with the feature sets of each of the frames in the set of frames from the second camera to identify a second frame that most closely corresponds to the first frame (406). Communication module 220 synchronizes the first camera and the second camera based on the first frame of the first camera and the identified second frame of the second camera (408).

Example 1. A method comprising: causing, by one or more processors, a capturing of at least a first frame from a first camera and a set of frames from a second camera; processing, by the one or more processors, the first frame and each frame in the set of frames to extract feature sets for each captured frame; comparing, by the one or more processors, the feature set of the first frame from the first camera with the feature sets of each of the frames in the set of frames from the second camera to identify a second frame that most closely corresponds to the first frame; and synchronizing, by the one or more processors, the first camera and the second camera based on the first frame of the first camera and the identified second frame of the second camera.

Example 2. The method of Example 1, wherein the processing further comprises: de-warping, by the one or more processors, each captured frame to correct for lens distortion.

Example 3. The method of any one or more of Examples 1-2, wherein the processing further comprises: cropping, by the one or more processors, a region of interest from each de-warped frame corresponding to an overlapping area between the first camera and the second camera.

Example 4. The method of any one or more of Examples 1-3, wherein extracting the feature sets comprises: applying, by the one or more processors, an edge detection algorithm to each captured frame to identify edge features.

Example 5. The method of any one or more of Examples 1-4, wherein comparing the feature set of the first frame with the feature sets of the set of frames comprises: computing, by the one or more processors, a confidence score based on a quantity of matching edges.

Example 6. The method of Example 5, wherein computing the confidence score comprises: calculating, by the one or more processors, a standard deviation of the matching edge counts across the set of frames.

Example 7. The method of any one or more of Examples 1-6, wherein extracting the feature sets further comprises: filtering, by the one or more processors, the detected edges to retain a predetermined number of edge matches with the top scores.

Example 8. The method of any one or more of Examples 1-7, wherein synchronizing the first camera and the second camera comprises: determining, by the one or more processors, a frame offset value between the first frame and the second frame corresponding to a temporal delay determined based on the identified second frame.

Example 9. The method of Example 8, wherein synchronizing the first camera and the second camera further comprises: shifting, by the one or more processors, the frames from the second camera by the frame offset.

Example 10. The method of any one or more of Examples 8-9, further comprising: for each frame in the set of frames, determining, by the one or more processors, a confidence score based on the comparison of the feature set of the first frame and the feature set of the respective frame; determining a standard deviation of the confidence scores; and, in response to the standard deviation not meeting a threshold standard deviation, setting, by the one or more processors, the frame offset value to equal zero

Example 11. The method of any one or more of Examples 1-10, further comprising: buffering, by the one or more processors, a plurality of frames from the second camera to facilitate selection of the frame that yields the maximum confidence score during comparison.

Example 12. The method of any one or more of Examples 1-11, wherein processing the captured frames further comprises: converting, by the one or more processors, each frame to a grayscale format prior to performing de-warping and edge detection.

Example 13. The method of any one or more of Examples 1-12, wherein comparing the feature set of the first frame with the feature sets of the set of frames further comprises: applying, by the one or more processors, a k-neighbors matching algorithm followed by performing Lowe's ratio test to filter out low quality matches.

Example 14. The method of any one or more of Examples 1-13, wherein the set of frames each have a timestamp within a pre-defined range of a timestamp for the first frame.

Example 15. The method of any one or more of Examples 1-14, further comprising outputting a synchronized video stream comprising frames from the first camera and frames from the second camera temporally aligned based on the frame offset value.

Example 16. The method of any one or more of Examples 1-15, further comprising providing synchronized video feeds from the first camera and the second camera to a downstream video processing system, wherein the synchronized video feeds are temporally aligned based on the frame offset value.

Example 17. A method for performing any of the techniques of any combination of Examples 1-16.

Example 18. A device configured to perform any of the methods of any combination of Examples 1-16.

Example 19. An apparatus comprising means for performing any of the method of any combination of Examples 1-16.

Example 20. A non-transitory computer-readable storage medium having stored thereon instructions that, when executed, cause one or more processors of a computing device to perform the method of any combination of Examples 1-16.

Example 21. A system comprising one or more computing devices configured to perform a method of any combination of Examples 1-16.

Example 22. Any of the techniques described herein.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
causing, by one or more processors, a capturing of at least a first frame from a first camera and a set of frames from a second camera;
processing, by the one or more processors, the first frame and each frame in the set of frames to extract feature sets for each captured frame;
comparing, by the one or more processors, the feature set of the first frame from the first camera with the feature sets of each of the frames in the set of frames from the second camera to identify a second frame that most closely corresponds to the first frame; and
synchronizing, by the one or more processors, the first camera and the second camera based on the first frame of the first camera and the identified second frame of the second camera.

2. The method of claim 1, wherein the processing further comprises:
de-warping, by the one or more processors, each captured frame to correct for lens distortion.

3. The method of claim 2, wherein the processing further comprises:
cropping, by the one or more processors, a region of interest from each de-warped frame corresponding to an overlapping area between the first camera and the second camera.

4. The method of claim 1, wherein extracting the feature sets comprises:
applying, by the one or more processors, an edge detection algorithm to each captured frame to identify edge features.

5. The method of claim 1, wherein comparing the feature set of the first frame with the feature sets of the set of frames comprises:
computing, by the one or more processors, a confidence score based on a quantity of matching edges.

6. The method of claim 5, wherein computing the confidence score comprises:
calculating, by the one or more processors, a standard deviation of the matching edge counts across the set of frames.

7. The method of claim 1, wherein extracting the feature sets further comprises:
filtering, by the one or more processors, the detected edges to retain a predetermined number of edge matches with the top scores.

8. The method of claim 1, wherein synchronizing the first camera and the second camera comprises:
determining, by the one or more processors, a frame offset value between the first frame and the second frame corresponding to a temporal delay determined based on the identified second frame.

9. The method of claim 8, wherein synchronizing the first camera and the second camera further comprises:
shifting, by the one or more processors, the frames from the second camera by the frame offset.

10. The method of claim 8, further comprising:
for each frame in the set of frames, determining, by the one or more processors, a confidence score based on the comparison of the feature set of the first frame and the feature set of the respective frame; determining a standard deviation of the confidence scores; and,
in response to the standard deviation not meeting a threshold standard deviation, setting, by the one or more processors, the frame offset value to equal zero.

11. The method of claim 1, further comprising:
buffering, by the one or more processors, a plurality of frames from the second camera to facilitate selection of the second frame from the set of frames that yields a maximum confidence score during comparison.

12. The method of claim 1, wherein processing the captured frames further comprises:
converting, by the one or more processors, each frame to a grayscale format prior to performing de-warping and edge detection.

13. The method of claim 1, wherein comparing the feature set of the first frame with the feature sets of the set of frames further comprises:
applying, by the one or more processors, a k-neighbors matching algorithm followed by performing Lowe's ratio test to filter out low quality matches.

14. The method of claim 1, wherein the set of frames each have a timestamp within a pre-defined range of a timestamp for the first frame.

15. The method of claim 1, further comprising outputting a synchronized video stream comprising frames from the first camera and frames from the second camera temporally aligned based on the frame offset value.

16. The method of claim 1, further comprising providing synchronized video feeds from the first camera and the second camera to a downstream video processing system, wherein the synchronized video feeds are temporally aligned based on the frame offset value.

17. A computing device comprising one or more processors configured to:
cause a capturing of at least a first frame from a first camera and a set of frames from a second camera;
process the first frame and each frame in the set of frames to extract feature sets for each captured frame;
compare the feature set of the first frame from the first camera with the feature sets of each of the frames in the set of frames from the second camera to identify a second frame that most closely corresponds to the first frame; and
synchronize the first camera and the second camera based on the first frame of the first camera and the identified second frame of the second camera.

18. The computing device of claim 17, wherein the processing further comprises:
de-warping each captured frame to correct for lens distortion.

19. The computing device of claim 18, wherein the processing further comprises:
cropping a region of interest from each de-warped frame corresponding to an overlapping area between the first camera and the second camera.

20. A non-transitory computer-readable storage medium having stored thereon instructions that, when executed, cause one or more processors of a computing device to:
cause a capturing of at least a first frame from a first camera and a set of frames from a second camera;
process the first frame and each frame in the set of frames to extract feature sets for each captured frame;
compare the feature set of the first frame from the first camera with the feature sets of each of the frames in the set of frames from the second camera to identify a second frame that most closely corresponds to the first frame; and
synchronize the first camera and the second camera based on the first frame of the first camera and the identified second frame of the second camera.
